(19) United States
(12) Patent Application Publication
(10) Pub. No.: US 2026/0262875 A1
(43) Pub. Date: Sep. 10, 2026

(54) BEVERAGE DISPENSING MACHINE COMPRISING A CLEANING DEVICE

(71) Applicant: Melitta Professional Coffee Solutions GmbH, Minden (DE)

(72) Inventors: Bernd BUCHHOLZ, Rahden (DE); Jörg OSTERMEIER, Stadthagen (DE); Elaine ELLERBROK, Herford (DE); Jan SCHULZE, Minden (DE); Horst SCHMIDT, Bad Oeynhausen (DE)

(73) Assignee: Melitta Professional Coffee Solutions GmbH, Minden (DE)

(21) Appl. No.: 19/162,501

(22) PCT Filed: Mar. 4, 2024
(86) PCT No.: PCT/EP2024/055623

§ 371 Date: Sep. 5, 2025

(30) Foreign Application Priority Data
Mar. 8, 2023 (DE) 10 2023 105 704.9

(51) Int. Cl. A47J 31/60

(52) U.S. Cl. CPC A47J 31/60

(57) ABSTRACT

A beverage dispensing machine, in particular a coffee machine, includes a cleaning device, at least one first beverage system and at least one second beverage system. The cleaning device has a common cleaning agent input unit for a cleaning agent for both beverage systems. A method for cleaning a beverage dispensing machine, in particular a coffee machine, includes a cleaning device, at least one first beverage system and at least one second beverage system is made available.

The invention relates to a beverage dispensing machine, in particular a coffee machine, having a cleaning device according to the preamble of claim 1 and a method for cleaning such a beverage dispensing machine.

Beverage dispensing machines, such as cold and hot beverage dispensing machines, in particular coffee machines, have beverage systems with various functional units, including pipes, heat exchangers, etc., for beverage production. In a coffee machine for the production of coffee, in particular coffee production with the addition of milk or milk foam, the beverage systems are a coffee system and a milk system.

The areas of the coffee and milk system of the coffee machine through which the hot or cold beverage flows, preferably the pipe(s), must be carefully cleaned regularly with a cleaning liquid. The cleaning liquid used for this is usually water in which a cleaning agent has been/is dissolved. In order to ensure sufficient cleaning in areas through which hot and/or cold beverages, especially milk, flow, a sufficient amount of cleaning agent must be added to the water.

“Areas through which hot and/or cold beverages flow” means in the following that only coffee, tea, water, chocolate/cocoa or milk or milk as part of a hot or cold beverage flows through the area or areas.

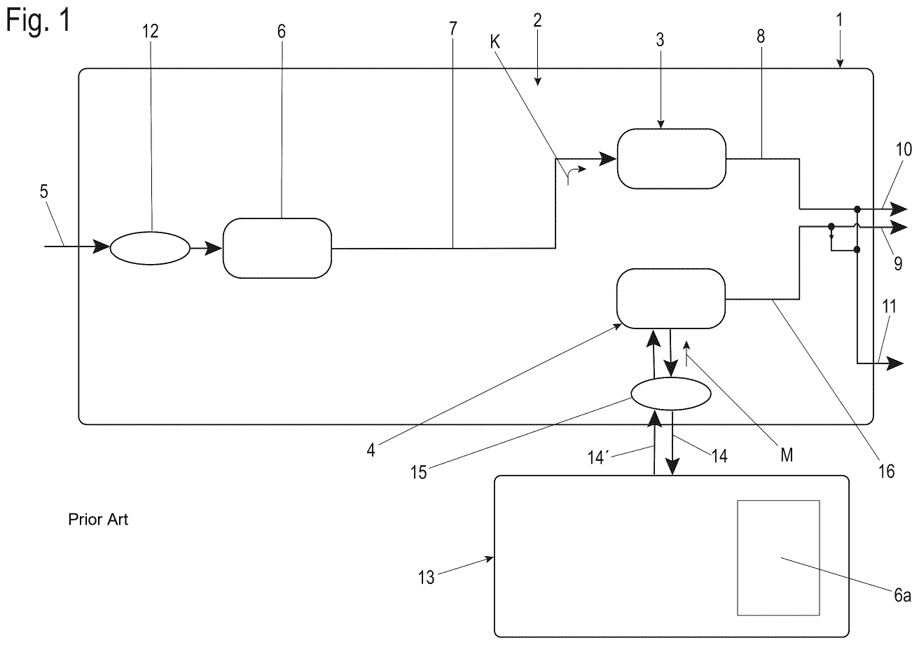

FIG. 1 shows a schematic block diagram of an exemplary embodiment of a coffee machine 1 having a cleaning device 2 according to the prior art.

The coffee machine 1 is a beverage preparation machine and is shown in simplified form. The description below is only exemplary and may also apply to other beverage preparation machines in a similar way.

The coffee machine 1 here comprises the cleaning device 2, at least one first beverage system 3 and at least one second beverage system 4. In the case of the coffee machine, the first beverage system 3 is a coffee system. The second beverage system 4 is a milk system.

The cleaning device 2 is used to clean the first beverage system 3 (coffee system), the second beverage system 4 (milk system) and the associated pipes.

The cleaning device 2 according to the prior art comprises a first cleaning agent input unit 6 for the first beverage system 3 (coffee system) and a separate second cleaning agent input unit 6a for the second beverage system 4 (milk system).

The first cleaning agent input unit 6 is arranged in a supply line 7 between the water inlet 5 and the first beverage system 3 (coffee system).

The first cleaning agent input unit 6 has a device for feeding a cleaning agent into the supply line 7. This cleaning agent can be in liquid or solid form. In solid form, the cleaning agent can, for example, be inserted into a suitable insertion part of the cleaning agent input unit. The cleaning agent is also referred to as a cleaning substance.

The first beverage system 3 (coffee system) is connected to the water inlet 5 via the supply line 7. The water inlet 5 can also be connected to a water container (not shown).

A water sensor 12 is also arranged in the supply line 7 to the first beverage system 3 (coffee system), which is used to detect a water pressure, a water quantity and also the quality of the water fed into the water inlet 5.

To prepare a beverage, the first beverage system 3 (coffee system) prepares a coffee beverage using the supplied water and ground coffee (not shown). The coffee beverage prepared in this way is supplied via a coffee line 8 through a beverage outlet 10.

An additive can be added to the coffee beverage. In this case, this additive is milk, which is drawn in by the second beverage system 4 (milk system) from a milk container (not shown) of a beverage unit (here: milk unit 13) by means of a milk inlet line 14, 14′ (more than one milk inlet line 14, 14′ can also be provided). Two arrows are shown in different directions for the milk inlet line 14, 14′. This is intended to symbolize that, on the one hand, milk is drawn out of the milk container in the direction of the arrow of the milk inlet line 14′. On the other hand, cleaning substance is fed through the milk inlet line 14, 14′ in both directions during a cleaning process, which is described in detail below.

The milk drawn in is then conveyed via a milk line 16 into an additive outlet 10. In this way, the additive is subsequently added through the additive outlet 9 to the coffee already present in a container under the outlets 9 and 10. It is of course also possible for coffee to be introduced into the container through the beverage outlet 10 and additive through the additive outlet 9 at the same time.

A milk sensor 15 is installed in the milk inlet line 14, 14′, which detects a flow rate in the milk inlet line 14, 14′. This flow rate relates to both additives and cleaning agents.

The milk unit 13 is usually cooled, e.g. a refrigerator.

The second cleaning agent input unit 6a is arranged here in the milk unit 13 and is designed, for example, as a container into which liquid cleaning agent can be poured.

Cleaning agent powder or tablets can be added and dissolved in water.

During a cleaning process, the first beverage system 3 (coffee system) and the second beverage system 4 (milk system) are cleaned separately by means of the cleaning device 2, starting from the two different cleaning agent input units 6 and 6a.

The first beverage system 3 (coffee system) is cleaned via a first cleaning path K (coffee cleaning path). This cleaning path K runs from the first cleaning agent input unit 6, through the supply line 7, the first beverage system 3 (coffee system) and the coffee line 8 into the outlet 11.

A separate milk cleaning path M is provided for the second beverage system 4 (milk system). The milk cleaning path M runs from the second cleaning agent input unit 6a, through the milk input line 14, the second beverage system 4 (milk system), the milk line 16 and then into the outlet 11.

A cleaning agent for the first beverage system 3 (coffee system) is fed into the first cleaning agent input unit 6, mixed with or dissolved in water and fed to the first beverage system 3 (coffee system) through the supply line 7 via the first cleaning path K (coffee cleaning path). The cleaning liquid then flows through the coffee line 8 into an outlet 11, where the coffee line 8 is cleaned.

A further cleaning agent for the second beverage system 4 (milk system) is filled into the second cleaning agent input unit 6a, which is designed, for example, as a container. Before this, a part of the milk inlet line 14, 14′, which is usually flexible, is removed from a milk container and inserted into the second cleaning agent input unit 6a. The cleaning agent can then be drawn out of the cleaning agent input unit 6a from the second beverage system 4 (milk system) via the milk input line 14, 14′ and fed via the milk cleaning path M. After cleaning the second beverage system 4 (milk system), the cleaning agent passes through the milk line 16 into the outlet 11. In this way, the milk line 16 is cleaned.

After the cleaning process, the first beverage system 3 (coffee system), the second beverage system 4 (milk system) and the associated pipes can be rinsed with water, for example.

The document DE 10 2011 077 435 A1 relates to a cleaning system for hot beverage dispensing machines.

The document EP 1 911 382 A1 specifies a device for preparing and dispensing beverages with a cleaning device.

The document DE 10 2013 112 130 A1 describes a method for detecting cleaning agents in a beverage dispensing machine, in particular a coffee machine.

These embodiments have proven themselves, but there is a constant need for improvements in the course of cost savings on components, functional groups, assembly times and maintenance.

The invention therefore has the object of improving a beverage dispensing machine, in particular a coffee machine, with a cleaning device, wherein simplification of cleaning and cost savings can be achieved.

A further object is to specify an improved method for cleaning a beverage dispensing machine.

The invention solves this object by a beverage dispensing machine comprising a cleaning device having the feature of claim 1 and by a method for cleaning a beverage dispensing machine according to claim 10.

A beverage dispensing machine according to the invention, in particular a coffee machine, comprises a cleaning device, at least one first beverage system and at least one second beverage system. The cleaning device has a common cleaning agent input unit for a cleaning agent for both beverage systems.

One advantage is that, in contrast to the prior art, a cleaning agent only needs to be added at one point and can be used for both the first beverage system (coffee system in a coffee machine) and the second beverage system (milk system in a coffee machine).

The term “common” cleaning agent input unit means that the cleaning agent filled in here is used for both beverage systems.

A method according to the invention for cleaning a beverage dispensing machine, in particular a coffee machine, having a cleaning device, at least one first beverage system and at least one second beverage system, comprises the following method steps: (VS1) feeding a cleaning agent or cleaning substance in solid, liquid and/or powdered form into a cleaning agent input unit of the cleaning device common to both beverage systems (3, 4), preparing a beverage unit, in particular a milk unit, for a 15 cleaning process, and starting a cleaning process of the beverage dispensing machine; (VS2) distributing the cleaning agent or cleaning substance, in particular as a cleaning agent concentrate, by means of a distribution unit of the cleaning device into a first cleaning path for the first beverage system and into a second cleaning path for the second beverage system; and (VS3) cleaning both the first beverage system and the second beverage system with the same cleaning agent or cleaning substance.

It is particularly advantageous here that the cleaning agent input from the cleaning agent input unit common to both beverage systems is distributed to the cleaning paths belonging to a respective beverage system by means of the distribution unit, wherein the same cleaning agent is used for both systems.

Advantageous designs are described in the subclaims.

In one embodiment, the cleaning device comprises the common cleaning agent input unit, a common supply line, a first line, a second line and a distribution unit. This results in an advantageously simple and compact design.

A further embodiment provides for the common supply line to form a common cleaning path from the common cleaning agent input unit to the distribution unit, which branches at the distribution unit into a first cleaning path for the first beverage system and a second cleaning path for the second beverage system. One advantage here is a reduced number of lines with lower assembly and parts costs.

In a further embodiment, the distribution unit is a branch of the common supply line, i.e. the common cleaning path. This can be advantageously achieved by means of a simple line branch, i.e. a low-cost component.

An alternative embodiment provides for the distribution unit to have either a branching valve or a valve for the first line and a valve for the second line. In this way, an advantageous controllable selection for cleaning both systems simultaneously, sequentially or individually is achieved.

It is advantageous if the cleaning device has a sensor for detecting and monitoring the cleaning agent, which is arranged on the distribution unit or/and in the distribution unit, as this can be used to determine whether cleaning agent is present or no longer present.

In another embodiment, an additional storage container for the cleaning substance and/or the cleaning concentrate is arranged in the common supply line. A particular advantage of the storage container for the cleaning substance and/or the cleaning concentrate is the homogeneity and process stability of the cleaning process. With the storage container, it is also advantageously possible to reduce the number of cleaning agent inputs, as a cleaning substance can be prepared and stored in advance for subsequent cleaning processes.

In a further embodiment, the cleaning device has at least one descaling unit. This is an advantageous extension of the cleaning of the beverage dispensing machine.

In another embodiment, the beverage dispensing machine has an exchangeable module unit with storage containers for cleaning agent and/or descaler. This is of great advantage as the storage containers of the modular unit can be filled beforehand at a suitable location and can then be easily and quickly exchanged for the modular unit with empty storage containers of the beverage dispensing machine. This results in an advantageously simple storage and input of cleaning agent.

In one embodiment of the method, it is provided that in the method step of feeding (VS1), the fed cleaning agent or the fed cleaning substance is mixed with water and prepared. This is advantageous as it allows the cleaning agent to be mixed individually.

If the cleaning agent or cleaning substance is stored in a storage container, several cleaning processes can be advantageously possible with one input or filling of cleaning agent.

In a further embodiment of the method, it is provided that in the second method step of distribution (VS2), the cleaning paths (K′ and M′) are acted upon simultaneously, in chronological order one after the other or individually for themselves with the same cleaning agent or cleaning substance. In this way, it is advantageously possible, for example, to clean the cleaning paths individually, even several times.

It is also advantageous if, during cleaning in the third method step of cleaning (VS3), the presence of the cleaning agent or cleaning substance in the cleaning paths, lines and beverage systems is detected and monitored by means of at least one sensor, as this enables greater food safety and ease of operation.

For this purpose, in a further embodiment of the method, it is advantageous if an acoustic and/or visual signal is emitted in the method step of cleaning (VS3) when the cleaning process is complete or there is no more cleaning agent or cleaning substance in the cleaning paths, lines and beverage systems. This results in simple and safe operation of the beverage dispensing machine.

In the following, the invention is described in more detail with reference to the drawings by means of an exemplary embodiment. The figures serve only to explain the invention in more detail and are not limiting for the invention. Individual features described can also be transferred to other embodiment variants within the scope of general technical knowledge, wherein:

FIG. 1: shows a schematic block diagram of an exemplary embodiment of a coffee machine having a cleaning device according to the prior art;

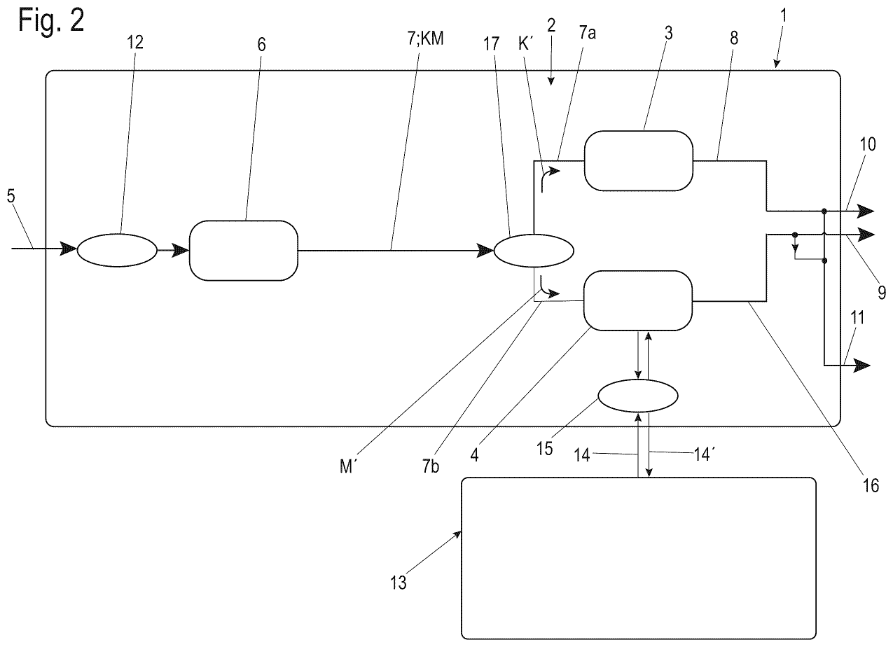

FIG. 2: shows a schematic block diagram of an exemplary embodiment of a coffee machine according to the invention having a cleaning device;

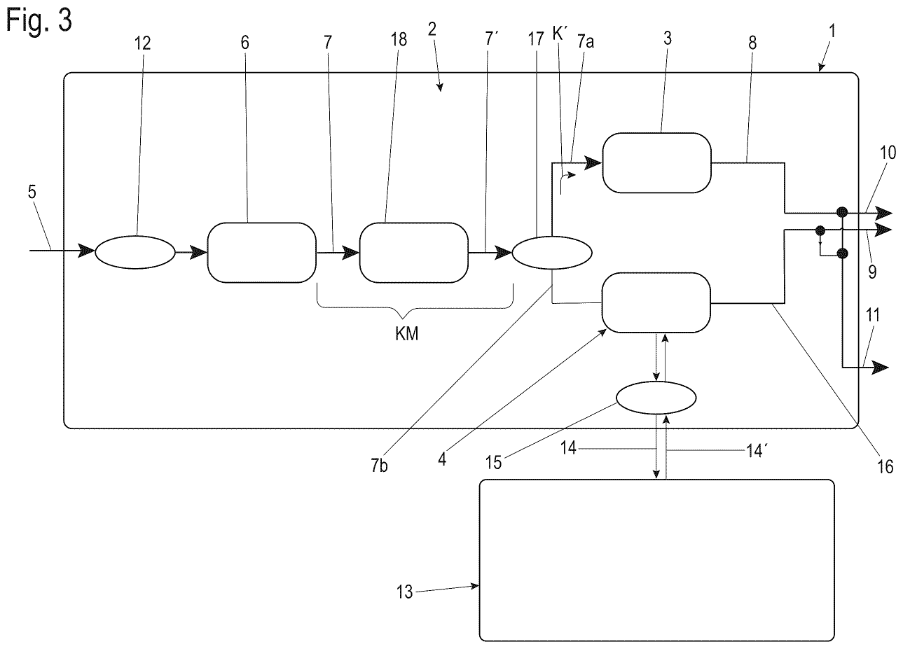

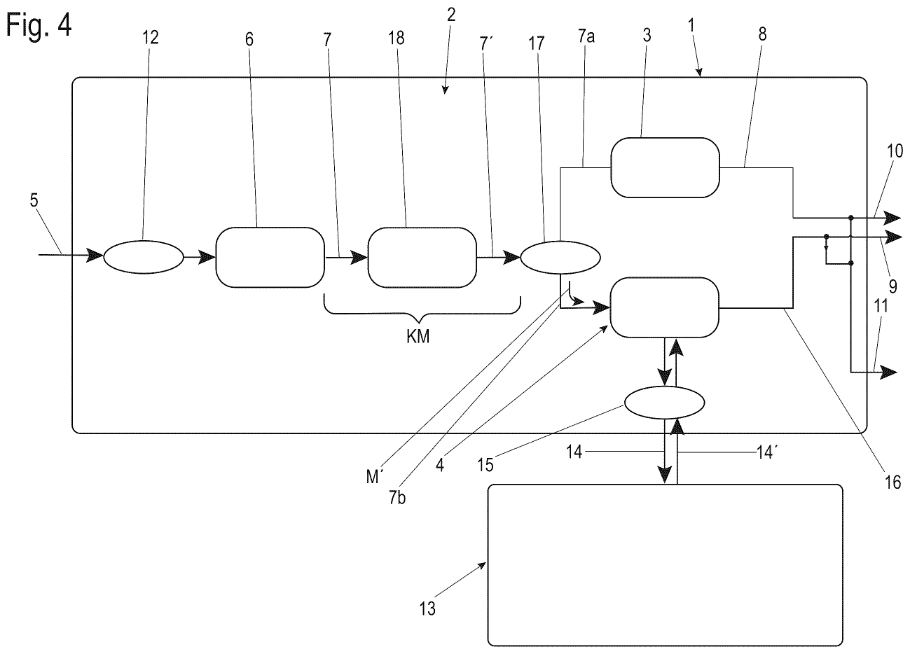

FIGS. 3-4: show schematic block diagrams of a first variant of the exemplary embodiment of the coffee machine according to the invention as shown in FIG. 2;

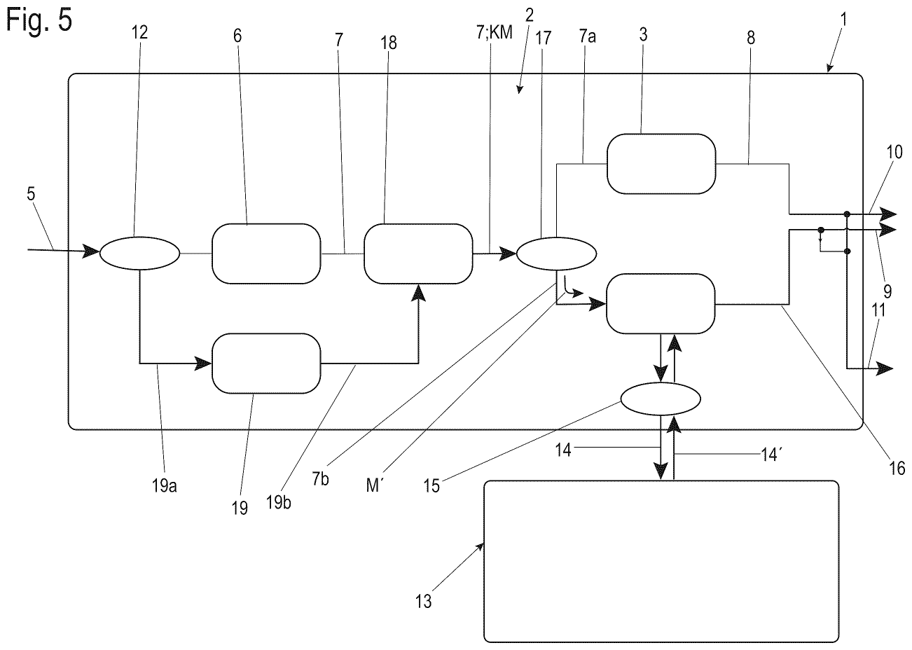

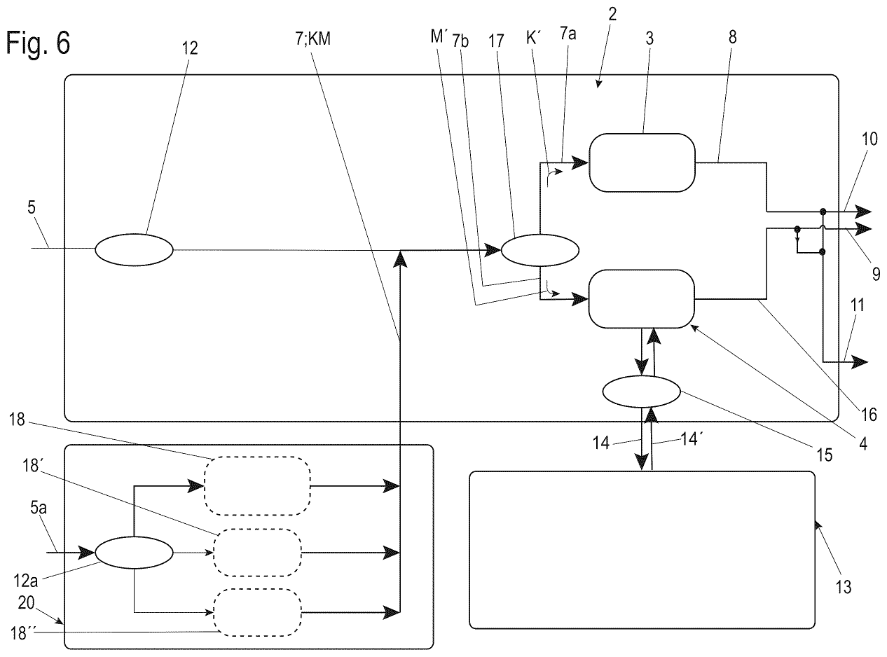

FIGS. 5-6: show schematic block diagrams of further variants of the exemplary embodiment of the coffee machine according to the invention as shown in FIG. 2; and

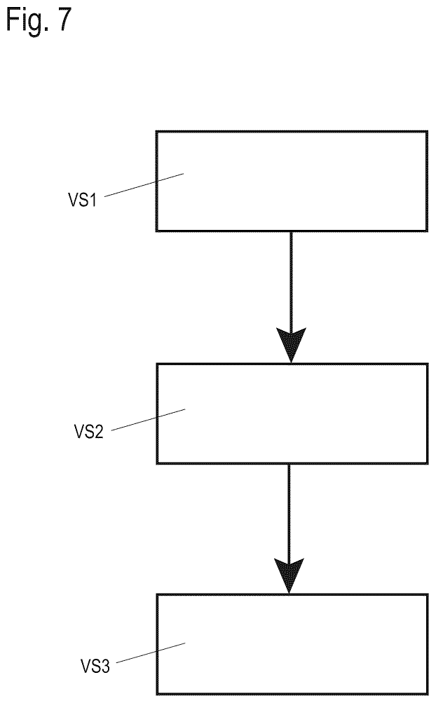

FIG. 7: shows a schematic flow chart of a method according to the invention.

FIG. 1 has already been described above.

FIG. 2 shows a schematic block diagram of an exemplary embodiment of a coffee machine 1 according to the invention with a cleaning device 2.

The coffee machine 1 according to the invention comprises the cleaning device 2, at least one first beverage system 3 (coffee system) and at least one second beverage system 4 (milk system).

In contrast to the coffee machine 1 having the cleaning device 2 from the prior art, the coffee machine 1 according to the invention has a cleaning device 2 with only one cleaning agent input unit 6, i.e. with a common cleaning agent input unit 6. In other words, the cleaning agent input unit 6 is used to clean both the first beverage system 3 (coffee system) and the second beverage system 4 (milk system). Only one cleaning agent needs to be fed into the common cleaning agent input unit 6. This one cleaning agent cleans both systems, i.e. the first beverage system 3 (coffee system) and the second beverage system 4 (milk system).

The cleaning device 2 here comprises a common cleaning agent input unit 6, a supply line 7, a first line 7a, a second line 7b and a distribution unit 17.

Starting from the common cleaning agent input unit 6 to the distribution unit 17, the supply line 7 forms a common cleaning path KM, which branches at the distribution unit 17 into a first cleaning path K′ (coffee cleaning path) and a second cleaning path M′ (milk cleaning path).

From the distribution unit 17, the first cleaning path K′ (coffee cleaning path) runs through the first line 7a, the first beverage system 3 (coffee system), the coffee line 8 and then into the outlet 11.

The second cleaning path M′ (milk cleaning path) also starts at the distribution unit 17 and then runs through the second line 7b, the second beverage system 4 (milk system), the milk line 16 9 and finally into the outlet 11.

In a first embodiment, the distribution unit 17 can be a simple branch of the supply line 7, i.e. the common cleaning path KM.

In a second embodiment, the distribution unit 17 has either a branching valve or two individual valves, one for the first line 7a and one for the second line 7b. The valves are not shown, but are easily imaginable. They are suitably controlled by a control unit of the coffee machine 1.

In the case of the branching valve, either the first line 7a or the second line 7b is connected to the supply line 7. In other words, in one position of the branching valve, only the first cleaning path K′ (coffee cleaning path) is supplied with cleaning agent or only the second cleaning path M′ (milk cleaning path).

In the case of the two individual valves, it is possible that either only the first cleaning path K′ (coffee cleaning path) or only the second cleaning path M′ (milk cleaning path) or both, i.e. the first cleaning path K′ (coffee cleaning path) and the second cleaning path M′ (milk cleaning path) are supplied with cleaning agent.

Before a cleaning process, in which the second beverage system 4 (milk system) and the milk unit 13 are included, suitable preparations are required in the milk unit 13.

These preparations concern parts of the milk inlet line, in particular flexible parts that are in contact with the milk, for example in a milk container or milk containers. In certain embodiments of the milk unit 13, these parts must then be removed from the milk container(s) and placed in a suitable collecting vessel or in an outlet. After the cleaning process, these parts must be placed back into the (possibly new) milk container(s). This is not shown here, but is easy to understand and will not be explained further.

During the cleaning process, the beverage outlet 10 can also be switched on in addition to the outlet 11, e.g. by means of a valve.

The distribution unit 17 is also equipped with a sensor. This sensor determines whether cleaning agent is present during the cleaning process and whether there is no more cleaning agent in the water fed into the supply line 7 at the end of the cleaning process. This ensures that no more cleaning agent affects a beverage during a subsequent brewing process.

This sensor for detecting the cleaning agent can be located on and/or in the distribution unit 17. This sensor can also be located at another point in the cleaning paths. Additional sensors of this type are also possible.

FIG. 3 shows a schematic block diagram of a first variant of the exemplary embodiment of the coffee machine 1 according to the invention with a cleaning device 2 according to FIG. 2 during a first cleaning process.

FIG. 4 shows the first variant of the exemplary embodiment shown in FIG. 3 during a second cleaning process.

In the first variant shown in FIG. 3 and FIG. 4, an additional storage container 18 for the cleaning substance or cleaning concentrate is inserted into the common cleaning path KM. The storage container 18 is connected to the cleaning agent input unit 6 via the supply line 7 and connected to the distribution unit 17 via a further supply line 7′.

The cleaning agent input unit 6 has a large device for inputting the cleaning agent. The cleaning agent, e.g. in tablet form, is inserted into a suitable tablet holder and pushed into the cleaning agent input unit 6.

With the supplied water from the water inlet 5, a cleaning concentrate is formed from the dissolved cleaning tablets (or cleaning liquid in another version) and fed into the internal storage container 18. The cleaning agent concentrate stored in the storage tank 18 is then distributed by the distribution unit 17 to the first cleaning path K′ (coffee cleaning path) via the first line 7a, as indicated by the arrows in FIG. 3.

A distribution of the cleaning agent concentrate from the storage container 18 by means of the distribution unit 17 to the second cleaning path M′ (milk cleaning path) via the second line 7b is shown in FIG. 4 by the indicated arrows.

The advantages of the storage container 18 for the cleaning agent concentrate are the homogeneity and process stability of the cleaning process.

FIGS. 5-6 show schematic block diagrams of further variants of the exemplary embodiment of the coffee machine 1 according to the invention as shown in FIG. 2.

FIG. 5 shows a second variant in which a descaler input unit 19 is arranged parallel to the cleaning agent input unit 6. The descaler input unit 19 has an input connected to the water sensor 12 via a first line 19 and its output is connected to the storage tank 18 via a second line 19b.

The descaler input unit 19 is equipped with a device for inputting descaler as a liquid, powder or tablet or similar. The descaler is mixed with the water from the water inlet 5 and fed into the storage tank 18, from where it is distributed to the cleaning paths KM, K′ and M′ as described above for the cleaning agent.

FIG. 5 shows an example of the application of the descaler to the milk cleaning path M′.

The descaler is detected and monitored by the sensors (sensor in the distribution unit 17 and milk sensor 15) in the system.

The second line 19b of the output of the descaler input unit 19 can also be connected to an additional storage container for the descaler mixed with water in an embodiment that is not shown but is easy to understand.

FIG. 6 shows a third variant of the exemplary embodiment of the coffee machine 1 according to the invention as shown in FIG. 2 with an additional module unit 20.

Here, the module unit 20 has a further water inlet 5a, a further water sensor 12a, the storage container 18 for the cleaning agent concentrate, a further (additional) storage container 18′ for the cleaning agent concentrate and a storage container 19 for the descaler.

The storage containers 18, 18′, 18″ are each provided with associated input units 6, 6a, 19 (not shown, but easily imaginable).

The cleaning agent concentrates and the descaler can be automatically dosed from their storage containers 18, 18′, 18″ into the supply line 7 or into the common cleaning path KM during the cleaning processes of the cleaning device 2. This is indicated schematically with arrows.

For this purpose, it is also possible that the cleaning agents and the descaler are stored as liquid, powder or in tablet form in separate sections of the associated storage containers 18, 18′, 18″ before mixing with water and can be refilled by the operator at much longer intervals. This results in a high degree of automation of the coffee machine 1.

The water inlet 5 already present in the coffee machine 1 and the existing water sensor 12 can, for example, be retained if, for example, the module unit 20 is designed as a retrofit unit.

FIG. 7 shows a schematic flow diagram of a method according to the invention for operating the cleaning device 2 of the coffee machine 1.

In a first method step VS1, a cleaning agent, e.g. in solid, liquid or/and powdered form, is fed into the cleaning agent input unit 6. The milk unit 13 is suitably prepared for a cleaning process and the cleaning process is started.

Then, in a second method step VS2, the cleaning agent entered in this way is distributed as a cleaning agent concentrate into a first cleaning path K′ and a second cleaning path M′ by means of the distribution unit 17. It is possible that the same cleaning agent or cleaning substance is applied to the cleaning paths K′ and M′ simultaneously, one after the other in chronological order or individually.

The cleaning agent concentrate is mixed or treated with water. It can also be stored in a storage tank 18, 18′. The water is monitored for pressure, quantity and quality using a suitable sensor.

In a third method step VS3, both the first beverage system 3 and the second beverage system 4 are cleaned with the same cleaning agent. During cleaning, the presence of the cleaning agent in the cleaning paths K′, M′, lines and beverage systems 3, 4 is detected and monitored.

When the cleaning process is complete or there is no more cleaning agent in the cleaning paths K′, M′ and beverage systems 3, 4, this is signaled in a suitable manner, e.g. acoustically and/or visually.

The cleaning device 2 can be switched on by an operator as required or also when prompted by an operating system of the coffee machine 1 (e.g. on a display).

Cleaning agent or descaler as well as all cleaning paths K′ and M′ can be selected together or individually.

It is also possible for the cleaning processes of the cleaning device 2 to run automatically at specific time intervals.

The invention is not limited by the exemplary embodiment given above, but can be modified within the scope of the claims.

### LIST OF REFERENCE SIGNS

1 Coffee machine
2 Cleaning device
3 Coffee system
4 Milk system
5, 5a Water inlet
6, 6a Cleaning agent input unit
7, 7′ Supply line
7a First line
7b Second line
8 Coffee line
9 Additive outlet
10 Beverage outlet
11 Outlet
12,12a Water sensor
13 Milk unit
14,14′ Milk inlet line
15 Milk sensor
16 Milk line
17 Distribution unit
18, 18′, 18″ Storage container
19 Descaler input unit
19, 19b Line
20 Module unit
KM, K, K′; M, M′ Cleaning path
VS1, VS2, VS3 Method step

1. A beverage dispensing machine comprising: a cleaning device (2), at least one first beverage system (3) and at least one second beverage system (4),
wherein
the cleaning device (2) has a common cleaning agent input unit (6) for a cleaning agent for both beverage systems (3, 4).

2. The beverage dispensing machine according to claim 1, wherein the cleaning device (2) comprises the common cleaning agent input unit (6), a common supply line (7), a first line (7a), a second line (7b) and a distribution unit (17).

3. The beverage dispensing machine according to claim 2, wherein the common supply line (7), starting from the common cleaning agent input unit (6) up to the distribution unit (17), forms a common cleaning path (KM) which branches at the distribution unit (17) into a first cleaning path (K′) for the first beverage system (3) and into a second cleaning path (M′) for the second beverage system (4).

4. The beverage dispensing machine according to claim 2, wherein the distribution unit (17) is a branch of the common supply line (7), i.e. the common cleaning path (KM).

5. The beverage dispensing machine according to claim 4, wherein the distribution unit (17) has either a branching valve or a valve for the first line (7a) and a valve for the second line (7b).

6. The beverage dispensing machine according to claim 2, wherein the cleaning device (2) has a sensor configured for detecting and monitoring the cleaning agent, which is arranged on the distribution unit (17) or/and in the distribution unit (17).

7. The beverage dispensing machine according to claim 2, wherein an additional storage container (18) configured for storing the cleaning agent and/or the cleaning concentrate is arranged in the common supply line (7).

8. The beverage dispensing machine according to claim 1, wherein the cleaning device (2) has at least one descaler input unit (19).

9. The beverage dispensing machine according to claim 8, wherein the beverage dispensing machine has an exchangeable module unit (20) with storage containers (18, 18′, 18″) configured for storing cleaning agent and/or descaler.

10. A method for cleaning a beverage dispensing machine having a cleaning device (2), at least one first beverage system (3) and at least one second beverage system (4) according to claim 1, comprising the method steps of
(VS1) feeding a cleaning agent or cleaning substance in solid, liquid or/and powdered form into a cleaning agent input unit (6) of the cleaning device (2), preparing a beverage unit, for a cleaning process, and starting a cleaning process of the beverage dispensing machine;
(VS2) distributing the cleaning agent or cleaning substance thus introduced, by means of a distribution unit (17) of the cleaning device (2) into a first cleaning path (K′) for the first beverage system (3) and into a second cleaning path (M′) for the second beverage system; and
(VS3) cleaning both the first beverage system (3) and the second beverage system (4) with the same cleaning agent or cleaning substance.

11. The method according to claim 10, wherein in the method step of feeding (VS1), the fed cleaning agent or the fed cleaning substance is mixed with water and prepared.

12. The method according to claim 10, wherein the cleaning agent or the cleaning substance is stored in a storage container (18, 18′).

13. The method according to claim 10, wherein in the second method step of distributing (VS2), the cleaning paths (K′ and M′) are acted upon simultaneously, in chronological order one after the other or individually for themselves with the same cleaning agent or cleaning substance.

14. The method according to claim 1, wherein during cleaning in the third method step of cleaning (VS3), the presence of the cleaning agent or the cleaning substance in the cleaning paths (K′, M′), lines and beverage systems (3, 4) is detected and monitored by means of at least one sensor.

15. The method according to claim 10, wherein in the method step of cleaning (VS3), an acoustic and/or optical signal is emitted when the cleaning process is complete or when there is no more cleaning agent or cleaning substance in the cleaning paths (K′, M′), lines and beverage systems (3, 4).
